(19) United States
(12) Patent Application Publication
(10) Pub. No.: US 2007/0249501 A1
(43) Pub. Date: Oct. 25, 2007

(54) Methods, formulations and articles of manufacturing for disinfecting substances, products and structures

(75) Inventors: Ron Frim, Haifa (IL); Menachem Assaraf, LeHavim (IL)

Correspondence Address: Martin D. Moynihan;PRTSI, Inc., P.O. Box 16446, Arlington, VA, 22215, US

(73) Assignee: Bromine Compounds Ltd., Beer-Sheva (IL)

(21) Appl. No.: 11/808,492

(22) Filed: Jun. 11, 2007

Related U.S. Application Data
(63) Continuation-in-part of application No. PCT/IL05/01330, filed on Dec. 8, 2005.
(60) Provisional application No. 60/634,525, filed on Dec. 10, 2004.

(51) Int. Cl. A01N 35/10; A01N 33/18; A01P 1/00; A01P 13/00; A01P 3/00

(52) U.S. Cl. 504/344; 514/640

(57) ABSTRACT

Novel pesticide formulations, articles-of-manufacturing and methods for disinfecting substances, products or structures for controlling plant pests, utilizing bromopicrin, a degradation product thereof or an analog thereof are provided.

### RELATED APPLICATIONS

This application is a continuation-in-part of PCT International Patent Application No. PCT/IL2005/001330 filed on Dec. 8, 2005, which claims the benefit of U.S. Provisional Patent Application No. 60/634,525 filed on Dec. 10, 2004. The contents of the above Applications are all incorporated herein by reference.

### FIELD AND BACKGROUND OF THE INVENTION

The present invention relates to methods, formulations and articles of manufacturing which utilize bromopicrin or analogs thereof for disinfestation of products, substances, structures and the like. More particularly, the present invention relates to uses of bromopicrin and analogs thereof in controlling or eradicating pests such as plant pathogenic fungi, plant pathogenic nematodes, plant pathogenic bacteria, insects and weeds.

Soil disinfestation prior to planting is a common practice in modem agriculture, in particular for the production of high value crops. Presently, the most effective and most widely used soil disinfestation practice is soil fumigation with methyl bromide (MB). Accordingly, over 45 million pounds of MB were used for soil fumigation in the U.S. alone in 1995. Although effective in soil disinfestation, MB has been banned from use by the Montreal Treaty due to its damaging effect on the ozone layer and thus will entirely disappear from use in developed countries by the year 2005. In developing countries, MB consumption will be extended until 2015. Exemptions for developed and developing countries include quarantine, critical uses and certain pre-shipment uses. Consequently, the cost to agriculture in the U.S. alone from the impending ban on MB is estimated to exceed 1.5 billion dollar annually.

Currently there are only a few MB alternatives which are EPA registered and technically feasible for use in soil disinfestation. These include chloropicrin (trichloronitromethane), 1,3-dichloropropene and methyl isothiocyanates (e.g., metham sodium and dazomet). However, none of these and other MB alternatives which are currently registered and available, offers the broad-spectrum disinfection features of MB. Furthermore, environmental and health considerations may limit the use of these pesticides. Some alternative soil disinfestation agents, like 1,3-dichloropropene and methyl isothiocyanates, are particularly hazardous because of suspected carcinogenic or teratogenic properties.

Accordingly, major research efforts have been undertaken worldwide during the past decade to uncover alternative soil disinfestation agents which can replace MB (see for example www.ars.usda.gov/is/mb/mebrweb.htm).

Methyl iodide (iodomethane) is described in U.S. Pat. No. 5,518,692 as a wide spectrum soil fumigant which may be considered as an alternative to MB. However, methyl iodide is characterized by a long soil persistence period which may result in residual phytotoxicity following treatment and groundwater contamination (Martin, F., Ann. Rev. Phytopathol. 41: 325-350, 2003). In addition, methyl iodide is a very expensive chemical, a fact which may limit its use in developing countries.

Propargyl bromide has been recently reported as a fumigant being capable of controlling a wide spectrum of soil-borne plant pathogens (Ajwa et al., Phytopathologia Mediterrena 42: 220-244, 2003). However, similarly to methyl iodide, it is inherently limited by a long persistence period in soil (Yates et al., J. Environ. Qual. 25: 192-202, 1996).

Bromonitromethane is described in U.S. Pat. No. 5,013,762 as a fumigant which is effective against soil-borne nematodes. However, bromonitromethane has not been shown to be effective against other soil-borne pests such as fungi, bacteria, insects or weeds. In addition it is relatively unstable and therefore unsafe for use.

While reducing the present invention to practice, the present inventors have uncovered that fumigating soil with 1,1,1-tribromonitromethane (bromopicrin) can effectively eradicate pests, including plant pathogenic fungi, bacteria and nematodes in the soil. Although U.S. Pat. No. 5,411,990 and JP 9067212 describe methods of using liquid bromopicrin as an industrial biocide to prevent growth of noxious microorganisms in the water-system of paper and pulp industry, water based coating material, paper-coating agent, latex, printing paste, metal working fluid, adhesive, etc., the use of bromopicrin as a fumigant or as a plant pest controlling agent has not been described or suggested by these or any other prior art reference.

Thus, the present invention provides novel methods, formulations, and articles of manufacturing utilizing formulations comprising bromopicrin or analogs for disinfecting substances, products or structures and/or controlling plant pests effectively, reliably and safely.

### SUMMARY OF THE INVENTION

According to one aspect of the present invention there is provided a method of disinfecting a substance, product or structure comprising fumigating the substance, product or structure with a pesticidally effective amount of bromopicrin, thereby disinfecting the substance, product or structure.

According to another aspect of the present invention there is provided a method of soil disinfestation, comprising exposing the soil to a pesticidally effective amount of bromopicrin, thereby disinfecting the soil.

According to yet another aspect of the present invention there is provided a method of controlling a plant pest, comprising exposing an environment of the plant to a pesticidally effective amount of bromopicrin, thereby controlling the plant pest.

According to still another aspect of the present invention there is provided a pesticide formulation, comprising a pesticidally effective amount of bromopicrin and a carrier suitable for fumigation.

According to an additional aspect of the present invention there is provided an article of manufacturing, comprising a packaging material and a formulation being identified for use in the control of plant pests, the formulation including, as an active ingredient, a pesticidally effective amount of bromopicrin and a suitable carrier.

According to further features in preferred embodiments of the invention described below, the substance is a soil.

According to still further features in the described preferred embodiments the product is a post-harvest plant material.

According to still further features in the described preferred embodiments the fumigating of the soil is effected by shank injection, chemigation, drench application, trench application or handgun application.

According to still further features in the described preferred embodiments, the fumigating further comprising tarping the substance, product or structure with a plastic film concomitantly with or following the fumigating.

According to still further features in the described preferred embodiments the pesticidally effective amount of bromopicrin ranges between about 10 and 1,200 pounds/acre.

According to still further features in the described preferred embodiments the pesticidally effective amount of bromopicrin ranges between about 50 and about 800 pounds/acre.

According to still further features in the described preferred embodiments the pesticidally effective amount of bromopicrin ranges between about 100 and about 400 pounds/acre.

According to still further features in the described preferred embodiments the pesticidally effective amount of bromopicrin ranges between about 4 ounces/1000 cubic feet and about 100 pounds/1000 cubic feet.

According to still further features in the described preferred embodiments the pesticidally effective amount of bromopicrin ranges between about 8 ounces/1000 cubic feet and about 50 pounds/1000 cubic feet.

According to still further features in the described preferred embodiments the pesticidally effective amount of bromopicrin ranges between about 1 and about 10 pounds/1000 cubic feet.

According to still further features in the described preferred embodiments the fumigating of substance, product or structure further comprising fumigating the substance, product or structure with at least one additional pesticide.

According to still further features in the described preferred embodiments the at least one additional pesticide is selected from the group consisting of chloropicrin, metam sodium, 1,3-dichloroproprene, 1,2-dichloropropane, 1,2-dibromo-3-chloropropane, propargyl bromide, methyl bromide, methyl iodide, propylene oxide, methyl dibromide, phosphine, sulphur dioxide, hydrogen cyanide, carbonyl sulfide ethyl formate and sulfuryl fluoride.

According to still further features in the described preferred embodiments the ratio between the at least one additional pesticide and bromopicrin ranges between 1:10 and 10:1.

According to still further features in the described preferred embodiments the bromopicrin is provided with an inert carrier.

According to still further features in the described preferred embodiments the inert carrier includes at least one solvent.

According to still further features in the described preferred embodiments the solvent includes at least one compound selected from the group consisting of an alkane, a cycloalkane, an alcohol, a paraffin and an isoparaffin.

According to still further features in the described preferred embodiments the alkane is selected from the group consisting of n-heptane, isooctane, n-hexane and n-octane.

According to still further features in the described preferred embodiments the cycloalkane is selected from the group consisting of cyclohexane and methyl cyclohexane.

According to still further features in the described preferred embodiments the solvent includes a mixture of a paraffin and an isoparaffin.

According to still further features in the described preferred embodiments the mixture is Isopar C, Isopar E or Isopar G.

According to still further features in the described preferred embodiments the solvent includes a mixture of an alkane, such as, for example, heptane, and a cycloalkane, such as, for example, cyclohexane.

According to still further features in the described preferred embodiments the alcohol is selected from the group consisting of 1-propanol, isopropyl alcohol, tert-butyl alcohol, polyethylene glycol and allyl alcohol.

According to still further features in the described preferred embodiments the inert carrier includes an emulsifying agent.

According to still further features in the described preferred embodiments the exposing is effected by fumigating, impregnating, spraying, soaking, dipping, drenching, mixing or coating the pesticidally effective amount of bromopicrin in the environment of the plant.

According to still further features in the described preferred embodiments the environment of the plant is a soil.

According to still further features in the described preferred embodiments the environment of the plant is a structure.

According to still further features in the described preferred embodiments the carrier has a concentration of at least 0.5% by weight of the pesticide formulation.

According to still further features in the described preferred embodiments the carrier has a concentration of at least 1% by weight of the pesticide formulation.

According to still further features in the described preferred embodiments the carrier has a concentration of at least 5% by weight of the pesticide formulation.

According to still further features in the described preferred embodiments the at least one additional pesticide has a concentration of at least 5% by weight of the pesticide formulation.

According to still further features in the described preferred embodiments the at least one additional pesticide has a concentration of at least 50% by weight of the pesticide formulation.

According to still further features in the described preferred embodiments the at least one additional pesticide has a concentration of at least 95% by weight of the pesticide formulation.

Alternatively, the methods, pesticide formulation and article of manufacturing described above utilize a bromopicrin analog having the general formula: 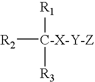
wherein: R₁, R₂, R₃ and Z are each independently a substituent selected from the group consisting of hydrogen, halo, nitro, cyano, hydroxy, thiohydroxy, alkoxy, thioalkoxy and amine; and X and Y are each independently absent or a carbon atom substituted by two substituents, each substituent is independently selected from the group consisting of hydrogen, halo, nitro, cyano, hydroxy, thiohydroxy, alkoxy, thioalkoxy and amine; provided that the compound comprises at least two halo substituents and at least one nitro substituent, with the proviso that the compound is not chloropicrin.

According to further features in preferred embodiments of the invention described below, X and Y are each absent.

According to still further features in the described preferred embodiments at least two of R₁, R₂ and R₃ are halo substituents, each is preferably independently selected from the group consisting of a bromo substituent and a chloro substituent.

According to still further features in the described preferred embodiments the at least two halo substituents are each a bromo substituent.

According to still further features in the described preferred embodiments the compound is dibromonitromethane.

According to still further features in the described preferred embodiments the compound comprises at least three halo substituents, at least one and preferably being a bromo substituent.

According to still further features in the described preferred embodiments the at least three halo substituents are each a bromo substituent.

According to further aspects of the present invention there are provided a method of disinfecting a substance, product or structure, a method of soil disinfestation, a method of controlling a plant pest, and a pesticide formulation, all utilizing bromonitromethane. The present invention successfully addresses the shortcomings of the presently known configurations by providing new methods, formulations and articles of manufacturing which utilize bromopicrin, degradation products thereof or analogs thereof for disinfestation of substances, products or structures.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates the effect of tetrabromoethane (TBE) ethylene bromochloride (BCE) and bromopicrin (BP), applied to inoculated soil at a concentration of 30 (red bars) or 100 (blue bars) mg/Kg (ppm), on the population densities of total fungi, total bacteria, Streptomyces spp. and Fusarium oxysporum f. sp radicis-lycopersici (FORL), compared with non-treated inoculated soil (CK); Microbial colony-forming units (CFU) of the tested microorganisms were determined 7 days following application.

FIG. 2 illustrates the effect of various industrial biocides [methoxy cinnamic acid (MCA), tetramethylammonium bromide (TMBr), potassium metabisulfite (PMS), tribromoneopentyl alcohol (TBNPA), dibromoneopentyl glycol (DBNPG), a commercial biocide labeled BioYZ, and bromoform (BF), on the population densities of Fusarium oxysporum f. sp radicis-lycopersici (FORL), Verticillium dahliae, Macrophomina phaseolina and Streptomyces spp. in soil, compared with non-treated inoculated soil (CK); (Bromoform was not tested (NT) in treating Verticillium dahliae and Macrophomina phaseolina); Biocides were applied at a concentration of 30 (red bars) or 100 (blue bars) mg/Kg (ppm); Microbial colony-forming units (CFU) and percent survival values of the tested microorganisms were determined 7 days following application to soil.

FIG. 3 illustrates the effect of Bromopicrin (BP), a commercial biocide labeled BioXn, and Dazomet (Basamid®), applied to soil at a concentration of 30 (red bars), 50 (blue bars) or 100 (brown bars) mg/Kg (ppm), on the population densities of Fusarium oxysporum f. sp radicis-lycopersici (FORL), Verticillium dahliae, Macrophomina phaseolina and Streptomyces spp., compared with non-treated inoculated soil (CK); Microbial colony-forming units (CFU) and percent survival values of the tested microorganisms were determined 7 days following application to soil.

FIG. 4 illustrates the effect of Bromopicrin, applied to soil at different concentrations, on the population densities of Verticillium dahliae and Fusarium oxysporum f. sp radicis-lycopersici (FORL); Microbial colony-forming units (CFU) and percent survival values of the tested microorganisms were determined 7 days following Bromopicrin application to soil.

FIG. 5 illustrates the dissipation of bromopicrin (BP) and the generation of dibromonitromethane (DBNM), bromonitromethane (BNM) and nitromethane (NM) upon application of 50 mg bromopicrin to 1,000 grams of Rehovot sandy soil [95% sand].

FIG. 6 illustrates the effect of bromopicrin (BP) and of its degradation products (derivatives), dibromonitromethane (DBNM), bromonitromethane (BNM) and nitromethane (NM), each at a concentration of 30 mg/Kg (ppm w/w), on the population densities of Fusarium oxysporum f. sp radicis-lycopersici (FORL) (yellow bars) and S. rolfosii (red bars), in soil, compared with non-treated inoculated soil (left bars); percent survival values of the tested microorganisms were determined 7 days following application to soil.

### DESCRIPTION OF THE PREFERRED EMBODIMENTS

The present invention is of pesticide formulations comprising bromopicrin or an analog thereof, articles of manufacturing and methods of using same for disinfecting substances, products or structures for controlling plant pests.

The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

While reducing the present invention to practice the present inventors surprisingly uncovered that bromopicrin (BP) applied to soil at a concentration as low as 30 mg/Kg effectively eradicated soil-borne microorganisms in soil, including total (aerobic) bacteria, total fungi, Streptomycess spp., the pathogenic fungi Fusarium oxysporum f. sp. radicis-lycopersici, Verticillium dahliae and Macrophomina phaseolina (Example 1) and the root-knot nematode Meloidogyne javanica (Example 2). In sharp contrast, various industrial biocides, commonly used to protect industrial fluids from microbial contamination, were found ineffective against the same soil-borne microorganisms (Example 1). In addition, no residual phytotoxicity could be detected in bromopicrin-treated soil as little as ten days following application, indicating a rapid degradation of BP in soil (Example 3), a characteristic which is highly desired in fumigants. Furthermore, BP is a low-boiling liquid which may increase worker safety due to a substantially reduced probability of worker exposure compared with methyl bromide. In addition, BP demonstrates a high photolability which results in a very short resistance time in the atmosphere (from a few hours to a few days, depending on the solvent or carrier composition). The highly effective biocidal activity of bromopicrin combined with its short persistence in the environment and being safe to apply make it a promising candidate alternative to methyl bromide in disinfecting substances, products or structures.

Thus, according to one aspect of the present invention, there is provided a method of disinfecting a substance, product or structure by fumigating it with a pesticidally effective amount of bromopicrin.

As used herein the term “substance” refers to any solid matter which may harbor pests, such as a soil.

As used herein, the term “product” refers to any commodity or plant material which may harbor pests.

As used herein, the term “structure” refers to any structure which may harbor pests such as a building, warehouse, compartment, container or transport vehicle.

As used herein, the term “soil” refers to any natural soil or other medium used for growing plants such as, for example, peat moss, perlite, vermiculite, etc., or mixtures thereof.

As used herein, the term “disinfecting” refers to inactivating or killing pests which colonize the substance, product or structure targeted for disinfection.

As used herein, the term “fumigating” or “fumigation” refers to administering a gas phase pesticide (e.g., in the form of fume or vapor) for disinfecting the substance, product or structure. Fumigation can be effected by applying a gaseous pesticide or, preferably, by applying a volatile liquid pesticide under conditions enabling volatilization of the pesticide to thereby expose the pests harboring the substance, product or structure to the pesticide vapor.

As used herein, the term “pest” refers to any organism which is damaging to crops, humans or animals such as a pathogenic, parasitic or competitive organism.

The following section provides examples of pests which infest substances, products or structures and can be targeted by the disinfecting method of the present invention.

Examples of soil colonizing (soil-borne) pests include any soil-borne plant pathogenic fungi, plant pathogenic bacteria, plant pathogenic nematodes, plant insects and weeds. Soil-borne pathogenic fungi include, but not limited to, Cylindrocarpom spp., Fusarium spp., Phoma spp., Phytophtora spp., Pythium spp., Rhizoctonia spp., Sclerotinia spp., Verticillium spp. and Macrophomina spp. Soil-borne plant pathogenic bacteria include, but not limited to Pseudomonas spp., Xanthomonas spp., Agrobacterium tumefaciense, Corynobacterium spp. and Streptomycess spp. Plant pathogenic nematodes include, but not limited to, Meloidogyne spp., Xiphinema spp., Pratylenchus spp., Longidorus spp., Paratylenchus spp., Rotylenchulus spp., Helicotylenchus spp., Hoplolaimus spp., Paratrichodorus spp., Tylenchorhynchus spp., Radopholus spp., Anguina spp., Aphelenchoides spp., Bursapehlenchus spp., Ditylenchus spp., Trichchodorus spp., Globodera spp., Hemicycliophora spp., Heterodera spp., Dolichodorus spp., Criconemoides spp., Belonolaimus spp. and Tylenchulus semipenetrans. Soil-borne plant insect pests include, but not limited to wireworms, thrips, beetle larva, grubs, fungal gnat larvae, mealy bugs, phylloxera, ants and termites. Weeds include, but not limited to, purple nutsedge (Cyperus rotundus), smooth pigweed (Amaranthus hybridus), barnyard grass (Ecinocila crus-galli), cheeseweed (Malva spp.), field bindweed (Convolvulus arvensis), annual bluegrass (Poa annua); bermuda grass; crab grass; foxtail; purs lane; and witchweed.

Examples of product colonizing pests include any plant or animal insects such as, but not limited to, stored product insects (e.g., Tribolium spp., Rhizoperha dominicana, Oryzaephilus surinamensis, Ephestia spp. and Plodia interpunctella), mediterenian fruit fly (Ceratitus capitata), other fruit flies, white flies, fruit weevles, lepidoptera, beetes, scale insects, aphids, mealy bugs, thrips, and termites. Additional commodity colonizing pests include nematodes, plant pathogenic fungi and wood decay fungi.

Examples of structure colonizing pests include stored products insects, wood-boring insects, wood decay fungi ants, hygiene insect pests and termites.

As is mentioned hereinabove, the method of the present invention utilizes a pesticidally effective amount of bromopicrin, which was surprisingly identified by the present inventors as an effective yet safe fumigant capable of eradicating a wide variety of pests.

Bromopicrin (1,1,1-tribromonitromethane, CBr₃NO₂) is a liquid, photolabile, and slightly soluble in water chemical, having a molecular weight of 297.7, boiling point at 89-90° C./20 mm Hg (127° C./118 mm Hg), melting point at 10° C. and a specific gravity of 2.79.

Bromopicrin can be applied to disinfect a substance, product or structure pest per se or as a part (active ingredient) of a pesticide formulation. Preferably, the pesticide formulation further includes a carrier suitable for fumigation.

The term “carrier” used herein refers to an inert and environmentally acceptable material, which may be inorganic or organic and of synthetic or natural origin, with which the active compound is mixed or formulated to facilitate its application, or its storage, transport and/or handling.

A suitable carrier preferably includes one or more solvents to improve the stability and/or dispersion of the pesticide formulation. A suitable solvent may include at least one compound selected from the group consisting of the following: alkanes, cycloalkanes, alcohols, paraffins, isoparaffins, haloalkanes, haloalkenes and any mixture thereof.

Representative examples of alkanes that are suitable for use in the context of the present invention include, without limitation, n-heptane, isooctane, n-hexane, n-octane and any mixture thereof.

Representative examples of cycloalkanes that are suitable for use in the context of the present invention include, without limitation, cyclohexane, methyl cyclohexane, ethyl cyclohexane, cycloheptane, cyclooctane and any mixture thereof.

Representative examples of alcohols that are suitable for use in the context of the present invention include, without limitation, 1-propanol, isopropyl alcohol, tert-butyl alcohol, allyl alcohol, polyethylene glycol 400 and any mixture thereof.

Representative examples of mixtures of the forgoing compounds that are suitable for use in the context of the present invention include, without limitation, a mixture of a paraffin and an isoparaffin such as, for example, the commercially available Isopar G, Isopar C or Isopar E (Exxo Mobil Chemical Corporation), and a mixture of an alkane and a cycloalkane such as, for example, a mixture of heptane and cyclohexane.

Preferably, the concentration of the solvent or solvents in the pesticide formulation of the present invention is at least 5%, more preferably at least 10%, most preferably 20% by weight.

Alternatively, or additionally, a suitable carrier may include an emulsifying agent. A suitable emulsifying agent can be, for example, Atlox.

Optionally, bromopicrin may be absorbed into a granular, dust or other finely divided solid carrier such as, for example, chalk, talc, pyrophyllite, attapulgite, fuller's earth or bentonite.

The pesticide formulation of the present invention may further include one or more additional pesticides in order to improve its efficiency, versatility and/or economics. A suitable additional pesticide according to the present invention can be, for example, chloropicrin, metam sodium, 1,3-dichloroproprene, 1,2-dichloropropane, 1,2-dibromo-3-chloropropane, propargyl bromide, methyl bromide, methyl iodide, propylene oxide, ethylene dibromide, phosphine, sulphur dioxide, hydrogen cyanide, carbonyl sulfide ethyl formate and sulfuryl fluoride. Preferably, the concentration of the additional pesticide or pesticides in the pesticide formulation of the present invention is preferably at least 5%, more preferably at least 30%, most preferably at least 50% by weight.

Preferably, the pest control composition of the present invention is kept in a suitable container as an article of manufacturing and identified for use in fumigation of a substance, product or structure or for use in controlling plant pests.

The bromopicrin containing formulations described above can be applied to the substance, product or structure using any one of several well-known fumigation techniques. Preferably, the specific fumigation technique utilized is selected according to the type of substance, product or structure fumigated and further according to the pest targeted.

Fumigating soil with a pesticidally effective amount of bromopicrin can be effected by using any of the methods known in the art for applying liquid fumigants to soil. Preferably, the fumigation is effected by shank injection, chemigation, drench application or handgun application.

Shank injection is the one most commonly used method to treat large-scale areas. The injection of the fumigant to soil can be effected via knife like blades called shanks. A tube carrying the product runs down the back of each shank to the tip. In traditional fumigation, the product is injected below the surface of properly prepared soil and applied in a narrow band as the fumigation equipment moves across the field. The surface of the soil is sealed or compacted by pulling a ring roller behind the fumigation equipment or behind a second tractor. Preferably, the fumigation is effected using a shank injection equipment which is also capable laying a plastic tarp over the treated soil and gluing together adjacent edges in one operation. Such a equipment is commonly used for large scale fumigating with methyl bromide.

Alternatively, fumigation of a large-scale area can be effected by applying the fumigant to soil via the irrigation system (chemigation). The fumigant can be accurately metered into the irrigation lines to ensure an even distribution throughout the field. Preferably, the fumigant is applied via a drip irrigation system to a properly prepared soil already covered with plastic tarps to improve the efficacy of fumigation.

Fumigation of small scale areas, such as experimental plots, nurseries, ornamental plantings and orchards, the fumigant can be hand-injected to soil using equipment with a holding tank connected to a hollow pointed base for penetrating the soil. A plunger device or drip device releases a known quantity of fumigant for each penetration. Alternatively, the fumigant can be mixed in water and applied by drench. Preferably, the treated soil is preferably covered with a plastic tarp immediately following fumigation to improve efficacy of fumigation. Preferably, the tarp is removed from soil after an exposure period ranging from one to eleven days following fumigant application then the soil is allowed to aerate for at least one week, more preferably two weeks, most preferably three weeks prior to planting.

The application of an effective amount of bromopicrin is directed at the top several inches of soil, preferably from 4 to 12 inches. A wide range of application rates of bromopicrin may be suitable for soil disinfection according to the teaching of the present invention and may vary for any given combination of crops, soils types and the target pests. In general, a pesticidally effective amount of bromopicrin ranges between about 10 and about 1,200 pounds/acre, more preferably between about 50 and about 800 pounds/acre, most preferably between about 100 and about 400 pounds/acre. Applications of bromopicrin at rates substantially in excess of 1,200 pounds/acre would not be expected to provide any significant advantage over applications within the preferred ranges specified herein, but are nonetheless regarded as well within the scope of the present invention.

Herein, the term “about” refers to ±10%.

Fumigation of products and structures (space fumigation) with an effective amount of bromopicrin is preferably effected by heating the fumigant, such as by passage through a heat exchanger, prior to delivery to a commodity or a structure. The treated commodity may be contained in a gas-tight compartment or covered with a gas-tight plastic tarp. The exposure of the commodity or structure to the fumigant may be effected for a period ranging from one to ten days. Following exposure, the fumigant is removed and the fumigated commodity or structure is allowed to aerate for at least one week, more preferably for at least two weeks, most preferably for at least three weeks, prior to allowing access to the fumigated commodity or structure.

A pesticidally effective amount of bromopicrin for space fumigation preferably ranges between about 4 ounces/1000 cubic feet and about 100 pounds/1000 cubic feet, more preferably between about 8 ounces/1000 cubic feet and about 50 pounds/1000 cubic feet, most preferably between about 1 and about 10 pounds/1000 cubic feet.

Bromopicrin can be utilized for controlling plant pests by exposing a substance, product or a structure harboring the plant pest, to a pesticidally effective amount of bromopicrin. Exposing the substance, product or a structure harboring the plant pest to bromopicrin, according to this aspect of the present invention, can be effected by fumigating, spraying, soaking, dipping, drenching, mixing, impregnating or coating.

Hence, the present invention provides pesticide formulations comprising bromopicrin, articles of manufacturing and methods of their use for disinfection of substances, products and structures and for controlling plant pests efficiently, safely and reliably.

While bromopicrin is considered as a promising pesticide, as is demonstrated herein, other polyhalogenated compounds, which may exert the same activity, efficacy, safety and/or reliability as bromopicrin, can be utilized in the pesticide formulations, articles of manufacturing and in the methods of their use for disinfection of substances, products and structures and for controlling plant pests described hereinabove, in addition to or instead of bromopicrin.

Such polyhalogenated compounds, according to the present invention, share the same structural and/or chemical features as bromopicrin, and typically have the general formula: 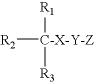
wherein:

R₁, R₂, R₃ and Z are each independently a substituent selected from the group consisting of hydrogen, halo, nitro, cyano, hydroxy, thiohydroxy, alkoxy, thioalkoxy and amine; and

X and Y are each independently absent or a carbon atom substituted by two substituents, each substituent is independently selected from the group consisting of hydrogen, halo, nitro, cyano, hydroxy, thiohydroxy, alkoxy, thioalkoxy and amine;

whereby the compound comprises at least two halo substituents and at least one nitro substituent.

As used herein throughout, the term “halo” substituent refers to fluoro, chloro, bromo or iodo.

A “hydroxy” substituent refers to an —OH group.

A “thiohydroxy” substituent refers to a —SH group.

An “alkoxy” substituent refers to both an —O-alkyl and an —O-cycloalkyl group, as defined herein.

A “thioalkoxy” substituent refers to both an —S-alkyl group, and an —S-cycloalkyl group, as defined herein.

An “amino” substituent refers to an —NR′R″ group where R′ and R″ are each independently hydrogen, alkyl or cycloalkyl, as defined herein.

A “nitro” group refers to a —NO₂ group.

A “cyano” group refers to a —C≡N group.

The term “alkyl” refers to a saturated aliphatic hydrocarbon including straight chain and branched chain groups. Preferably, the alkyl group has 1 to 10 carbon atoms. More preferably, the alkyl is a lower alkyl having 1 to 4 carbon atoms.

A “cycloalkyl” group refers to an all-carbon monocyclic or fused ring (i.e., rings which share an adjacent pair of carbon atoms) group wherein one or more of the rings does not have a completely conjugated pi-electron system. Examples, without limitation, of cycloalkyl groups are cyclopropane, cyclobutane, cyclopentane, cyclopentene, cyclohexane, cyclohexadiene, cycloheptane, cycloheptatriene, and adamantane.

Preferably, the halo substituents in the compounds above are chloro and/or bromo substituents. More preferably, the two or more halo substituents are present on the same carbon atom in the compounds above, such that in the general formula above, at least two of R₁, R₂ and R₃ are halo substituents. Alternatively, the two or more halo substituents are present on two or three carbon atoms, if present in the compound.

Further preferably, the compound bears at least three halo substituents.

As is demonstrated in the Examples section that follows, bromopicrin exerts higher biocidal activity, as compared with other halogenated compounds. This feature may suggest a role for the bromo substituents of bromopicrin and for their combination with the nitro substituent.

Hence, further preferably, at least one of the halo substituents is a bromo substituent whereby, more preferably, at least two of the halo substituents are bromo substituents, more preferably, at least three of the halo substituents are bromo substituents and, further preferably, all the halo substituents are bromo substituents.

As is depicted in the general formula hereinabove, the bromopicrin analogs may have one carbon atom, in cases where X and Y are both absent, two carbon atoms, in cases where either X or Y is absent, or three carbon atoms, in cases where both X and Y are present. However, due to efficacy, volatility, toxicity and spreadability considerations, it is preferred to use smaller compounds, such that preferably either X or Y is absent and, more preferably X and Y are both absent. Preferred compounds according to the present invention are therefore polyhalogenated nitromethanes or polyhalogenated nitroethanes.

As demonstrated in the Examples section that follows (see, Example 4), it has been found that bromopicrin, when applied to soil, generates dibromonitromethane (DBNM) and monobromonitromethane (bromonitromethane, BNM) as degradation products thereof. It has been further surprisingly found that these degradation products, particularly those possessing one or two bromo substituents, such as DBNM and BNM, exhibit by themselves a pesticidal activity.

Hence, in one preferred embodiment of the present invention, each of the methods and formulations described herein utilizes a compound having the general formula hereinabove, in which X and Y are both absent, Z is nitro and two of R₁, R₂, R₃ are bromo substituents. Preferably, such a compound is dibromonitromethane.

In additional preferred embodiments of the present invention, each of the methods and formulations described herein utilizes, as a pesticidally active agent, bromonitromethane.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below.

### Example 1

### The Effect of Administering Bromopicrin and other Organic Compounds to Field Soil on the Viability Of fungi and Bacteria

Materials and Methods:

Chemicals: 1,1,1-tribromonitromethane (CBr₃NO₂; bromopicrin; BP), dazomet (Basamid®), tetrabromoethane (C₂H₂Br₄; TBE), ethylene bromochloride (BCE), methoxy cinnamic acid (MCA), tetramethylammonium bromide (TMBr), potassium metabisulfite (K₂S₂O₅; PMS), tribromoneopentyl alcohol (C₅H₉Br₃O; TBNPA), dibromoneopentyl glycol (C₅H₁₀Br₂O₂; DBNPG), and bromoform (CHBr₃; BF), were evaluated for their effect on microorganisms in soil.

TABLE 1
Characteristics of tested chemicals*

| | Short | | | Solubility | Boil. Point | Melt. point | Vapor Pr. | Specific |
|---|---|---|---|---|---|---|---|---|
| Name | name | Appear | M.W. | in Water | (° C.) | (° C.) | (mm Hg) | gravity |
| TetraBromoEthane | TBE | Liquid | 345.7 | 0.063 g/100 ml | 119 | 1 | 0.04 | 2.96 |
| C₂H₂Br₄ | | | | | | | | |
| Ethylene Bromochloride | BCE | Liquid | 143.4 | Insoluble | 106 | −16.6 | 10 | 1.74 |
| Brompicrin | BP | Liquid | 297.7 | Slightly | 85 | 10 | NA | 2.79 |
| CBr₃NO₂ | | | | | | | | |
| Methoxy Cinnamic | MCA | White | 178.2 | NA | NA | 173 | NA | NA |
| Acid | | powder | | | | | | |
| Tetramethylammonium | TMBr | solid | 194 | Vary | NA | 230 | NA | NA |
| Bromide | | | | | | | | |
| Potassium Metabisulfite | PMS | Powder | 222.3 | 450 g/l | 190 | | | NA |
| K₂S₂O₅ | | | | | | | | |
| TriBromoNeoPentyl | TBNPA | Flakes | 324.8 | 1.93 g/l | NA | 65 | NA | 2.28 |
| Alcohol C₅H₉Br₃O | (Trinol) | | | | | | | |
| DiBromoNeoPentyl | DBNPG | Powder | 261.9 | 1.94 g/100 ml | 270 | 109 | NA | 2.23 |
| Glycol C₅H₁₀Br₂O₂ | (Dinol) | | | | | | | |
| Bromoform | BF | Liquid | 252.7 | Insoluble | 149 | 7 | 5.6 | 2.89 |
| CHBr₃ | | | | | | | | |
| Dazomet (Basamid ®) | | Solid | 162.3 | Insoluble | NA | 104 | NA | 0.6-0.8 |
| C₅H₁₀N₂S₂ | | | | | | | | |

*Data were taken from Material Safety Data Sheets (MSDS), which were provided with the chemicals. All chemicals were regarded as of analytical grade unless otherwise specified
NA - data which was not available

Preparation of inocula: in order to evaluate the effect of test chemicals on naturally occurring soil-borne plant pathogens, natural resting structures (propagules) 20 were used. Propagules of major pathogenic fungi were obtained as follows: Fusarium oxysporum f. sp. radicis-lycopersici (FORL) chiamidospores were generated as described by Gamliel et al. (Crop Protection 17:241-248, 1998) and Eshel et al (Crop Protection 18: 437-443, 1999). Verticillium dahliae microscletotia were collected from infected potato stems; Macrophomina phaseolina microsclerotia were collected from on infected watermelon stems. The propagules in stems were buried in soil at desired depths according to the procedure described by Gamliel et al. (Crop Protection 17:241-248, 1988) and Eshel et al. (Crop Protection 18: 437-443, 1999).

Evaluating efficacy of test chemicals in reducing viability of soil-borne fungi and bacteria: Rehovot sandy soil (water holding capacity of 10% w/w) was added to narrow-neck glass containers used as fumigation chambers according to the procedure described by Eshel et al. (Crop Protection: 18:437-443, 2000). Nylon bags containing inocula of pathogenic fungi were wetted to field capacity then buried in soil. Test chemicals were dissolved in distilled water at different concentrations than added to soil to field capacity. The dosage of tested chemicals was calculated as part per million (ppm) on a weight basis according to specific gravity. Immediately following application of test chemicals, each container was sealed with a glass lid and screw ring then incubated for seven days at 25° C. Following incubation, inoculum bags were retrieved from soil and the population densities of target microorganisms were determined using the standard plate dilution technique. The selective media used for enumerating colony forming units (cfu) of total bacteria, total fungi, Streptomycetes spp., FORL, Verticillium dahliae and Macrophomina phaseolina were as described by Gamliel et al. (Crop Protection 17:241-248, 1988) and Eshel et al. (Crop Protection 18: 437-443, 1999).

Results:

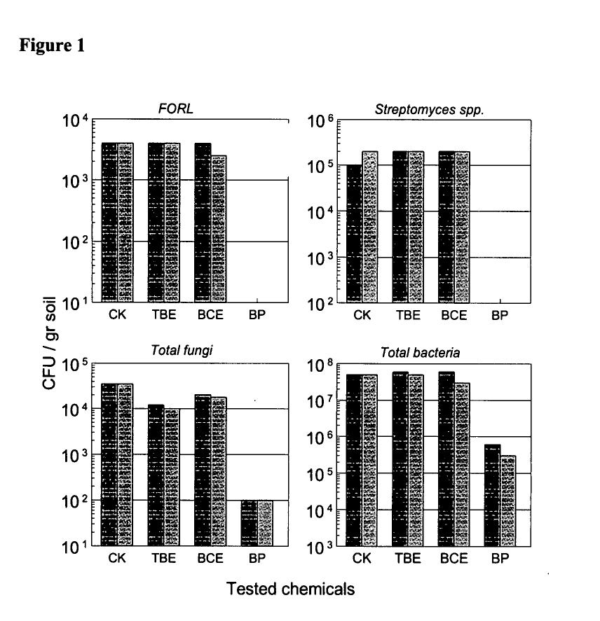

As can be seen in FIG. 1, bromopicrin (BP) applied to soil at a dosage of 30 ppm substantially reduced the population densities of various soil-borne fungi and bacteria. Thus, the density of FORL was reduced from about 4×10³ cfu/g in the untreated check to a non-detectable level (<10 cfu/g); the density of Streptomycetes spp. was reduced from about 10⁵ cfu/g in the untreated check to a non-detectable level (<10 cfu/g); the density of total aerobic bacteria was reduced from about 5×10⁷ cfu/g in the untreated check to about 6×10⁵ cfu/g; and the density of total fungi was reduced from about 3×10⁴ cfu/g in the untreated check to about 10² cfu/g.

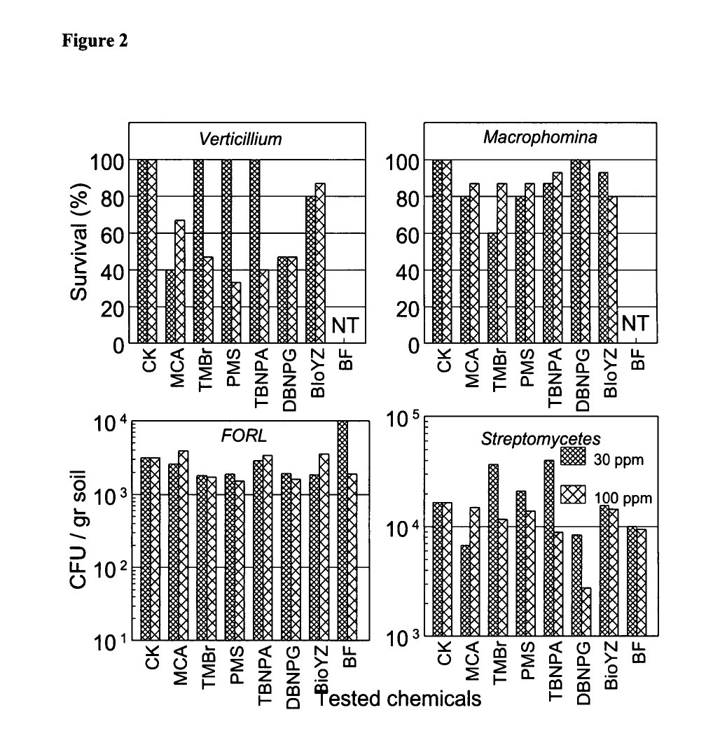

In comparison, the effects of various industrial biocides on soil microorganisms were tested under similar conditions. Accordingly, TBE, BCE, MCA, TMBr, PMS, TBNPA, DBNPG and BF, as well as the industrial biocide labeled as BioYZ, were applied to soil at 30 and 100 ppm. As can be seen in FIG. 2, none of the tested industrial biocides was capable of significantly reducing microbial populations in soil under the experimental conditions.

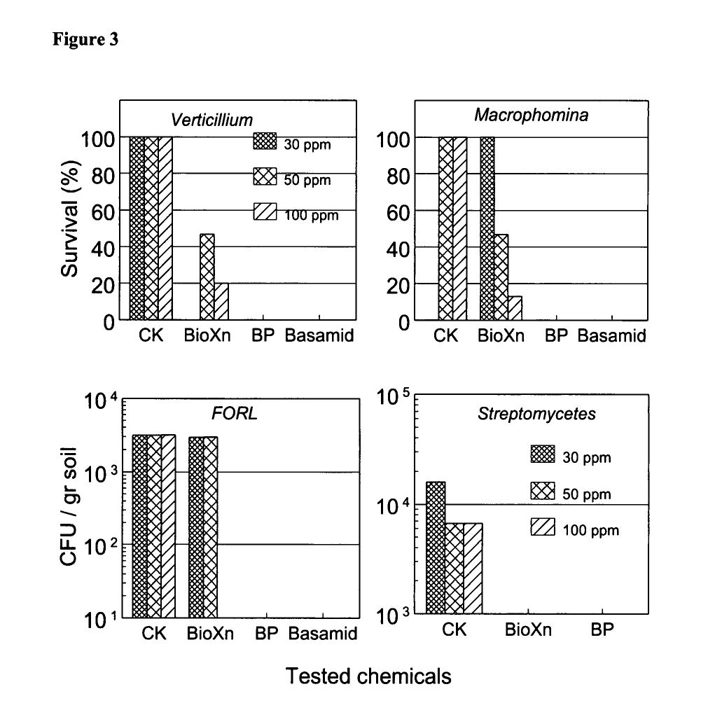

As can be seen in FIG. 3, bromopicrin applied to soil at 30 ppm reduced FORL density from about 3×10³ cfu/g in the untreated check to a non-detectable level (<10 cfu/g) and reduced Streptomycetes spp. density from about 1.5×10⁴ cfu/g in the untreated check to a non-detectable level (<10 cfu/g). Similarly, bromopicrin reduced Verticillium dahliae and Macrophomina phaseolina densities to a level being under 1% of the untreated check (a non-detectable level). As is further shown in FIG. 3, the effect of bromopicrin was similar to the effect of the commercial fumigant Basamid (positive control), while the industrial biocide labeled as BioXn was found ineffective.

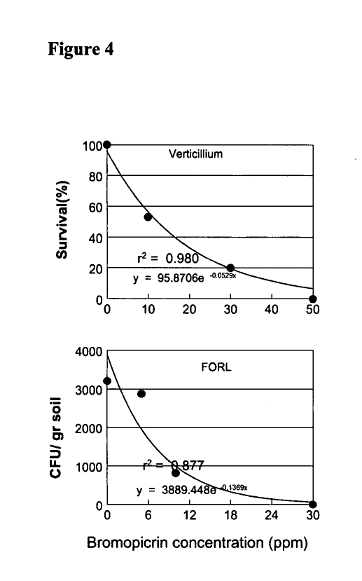

Dose response curves of bromopicrin vs. survival of pathogens in soil are illustrated in FIG. 4. The curves indicate that the bromopicrin concentrations being capable of reducing the densities of Verticillium dahliae and FORL in soil by half (LD₅₀ values) are about 12 and 6 ppm, respectively.

### Example 2

### The Effect of Bromopicrin Applied to Soil on the Survival of Root-Knot Nematode

Materials and Methods:

Chemicals: Bromopicrin and 1,3-dichloropropene were tested comparably for the control of the root-knot nematode Meloidogyne javanica in soil.

Evaluating test chemicals for their capacity to reduce viability of root knote nematode eggs: Tomato plant roots carrying eggs of the root-knot nematode Meloidogyne javanica were grounded, mixed and evenly distributed in nylon bags. The inoculated bags were buried in soil placed in placed in environmental chambers as described in Example 1 above. The containers were treated with bromopicrin and with 1,3-dichloropropene. Following treatment, the nematode inocula were retrieved from the nylon bags and mixed in raw soil which was then distributed into 4 inch pots. Seedlings of nematode-sensitive tomato cultivar were planted in each pot and allowed to grow in a greenhouse. Following three weeks incubation all plants were uprooted, washed and rated for galling index on a scale ranging from 0 (clean roots) to 4 (100% coverage of galls).

Results:

The galling index of plant roots grown in bromopicrin treated soil was zero, compared with galling index values of 3.5 and zero of plant roots grown in the negative control (untreated) and positive control (1,3-dichloropropene), respectively. Thus, bromopicrin was found equally effective as 1,3-dichloropropene in eradicating natural inocolum of the root knot nematode in soil.

### Example 3

### Residualphytotoxicity of Bromopicrin in Soil

Materials and Methods:

All test chemicals listed in Example 1, except dazomet, TBE and BCE, were applied to soil contained in fumigation chambers, as described in Example 1 above, at a dosage of 30 and 100 ppm. Following chemical treatment, the soil was left to aerate for ten days then placed in 4 inch size pots. Fourteen days old tomato (cv. 870) seedlings were planted in the pots and were allowed to grow for 21 days at 25° C. then were observed for symptoms of phytotoxicity.

Results:

No phytotoxicity was detected in plants grown in the bromopicrin treated soil. Interestingly, plants grown in soil which had been treated with bromopicrin at a dosage of 10-30 ppm developed larger root systems as compared with the untreated control. On the other hand, plants grown in soil which had been treated with PMS or BCE exhibited substantially stunted root system.

The results described herein indicate that bromopicrin is a highly potent fumigant capable of effectively controlling a wide spectrum of microorganisms in soil including major plant pathogenic fungi, bacteria and nematodes. In addition, the results show that no trace of residual phytotoxicity could be detected in soil which had been treated with pesticidally effective amount of bromopicrin just ten days after treatment. Hence, the combined effects of broad spectrum biocidal activity in soil and the low residual phytoxicity in soil shortly after treatment clearly render bromopicrin a prime prospect of a successful soil disinfecting agent and a potential suitable alternative to methyl bromide.

### Example 4

### Effect of Degradation Products of Bromopicrin on the Viability of Soil-Borne Fungi

Materials and Experimental Methods:

Nitromethane (NM) was purchased from Aldrich, Cat No. 10,817.0, lot. 535033-196.

Bromonitromethane (BNM) was purchased from Aldrich, 90% 255858.

Dibromonitromethane (DBNM) was obtained from TAMI, 90%, 38585-16-F-4.

Bromopicrin (BP) was obtained from TAMI, BP-2006-2.

HPLC analyses were performed using HP 1090 pumping system equipped with HP DAD 1090 UV detector operated at 220 nm and a C-18 Kromasil column, 250×4.6 mm, 100 A, 5 μm, using a mixture of 40% H₂O (pH adjusted to 2.5±0.2 with HClO₄) and 60% acetonitrile as the mobile phase, at a flow rate of 1 ml/minute.

Standard solutions were prepared in acetonitrile at a working concentration of about 100 mg/liter.

Degradation of Bromopicrin in Soil:

5 mg bromopicrin were applied to 1,000 grams of Rehovot sand soil (95% sand). 0.5, 3 and 7 days post-application, samples of the treated soil were extracted and analyzed by HPLC and GC-MS, so as to identify the ingredients therein.

The extraction procedure was effected by mixing 100 grams of the treated soil with 100 ml acetonitrile, for 30 minutes, followed by filtration.

HPLC analysis was performed as described hereinabove. Retenetion times: NM=3.3 minutes; BNM=4.3 minutes; DBNM=5.7 minutes; BP=7.9 minutes

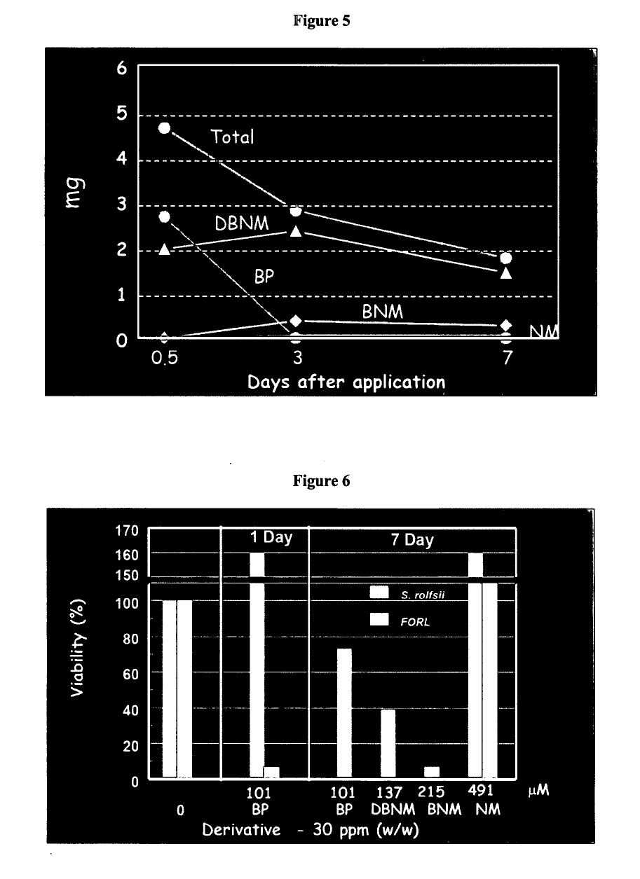

FIG. 5 presents the data obtained in the above-described studies, and shows the dissipation of bromopicrin and generation of its derivatives, as degradation products thereof, during the first week following application of bromopicrin to soil.

As shown in FIG. 5, bromopicrin rapidly dissipates in soil and degrades into lower bromonitromethane derivatives, such that dibromonitromethane is generated immediately and then dissipates to some extent, and monobromonitromethane is slowly yet consistently generated. Nitromethane is also generated during time, although to a much lesser extent.

Without being bound to any particular theory, it is suggested that bromopicrin degrades mostly to dibromonitromethane, which, in turn, further degrades to produce monobromonitromethane.

Effect of Bromopicrin and its Degradation Product on Soil-Borne Fungi:

In preliminary studies conducted so as to evaluate the effect of these degradation products on the viability and growth of soil-borne pests, their effect on two types of soil-borne fungi was studied, using the same experimental protocols as described hereinabove, with the exception of studies conducted with Sclerotium rolfsii in which sclerotia were used.

Viability of Sclerotium sclerotia was tested using the BromoCresol Green calorimetric method as follows: Sclerotium sclerotia that undergo germination secrete oxalic acid, which serves as a marker indicating their viability, by means of color change. When oxalic acid reacts with BromoCresol Green color change from blue to yellow is observed, indicating the amount of germinating sclerotia and hence their percent viability.

Thus, bromopicrin (BP), dibromonitromethane (DBNM), bromonitromethane (BNM) and nitromethane (NM), were prepared and applied each separately at a concentration of 30 mg/Kg (ppm, w/w), to 1,000 grams of Rehovot soil inoculated with Fusarium oxysporum f. sp radicis-lycopersici (FORL) or S. rolfosii.

FIG. 6 presents the data obtained in these studies as the percent survival values of the tested microorganisms, 7 days following application to soil, compared to non-treated soil as control, and clearly shows that both dibromonitromethane and monobromonitromethane are effective in controlling soil-borne fungi. It is further shown that nitromethane (NM) has no effect in controlling pests, as compared to the other degradation products.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, patent applications mentioned in this specification are herein incorporated in their entirety by reference into the specification, to the same extent as if each individual publication, patent, patent application was specifically and individually indicated to be incorporated herein by reference. In addition, citation or identification of any reference in this application shall not be construed as an admission that such reference is available as prior art to the present invention.

What is claimed is:

1. A method of disinfecting a substance, product or structure comprising fumigating the substance, product or structure with a pesticidally effective amount of bromopicrin, thereby disinfecting the substance, product or structure.

2. The method of claim 1, wherein said substance is a soil.

3. The method of claim 2, wherein said pesticidally effective amount of bromopicrin ranges between about 10 pounds/acre and about 1,200 pounds/acre.

4. The method of claim 1, further comprising fumigating said substance, product or structure with at least one additional pesticide.

5. The method of claim 1, wherein said bromopicrin is provided with an inert carrier.

6. A method of soil disinfestation, comprising exposing the soil to a pesticidally effective amount of bromopicrin, thereby disinfecting the soil.

7. The method of claim 6, further comprising administering to said soil at least one additional pesticide.

8. The method of claim 6, wherein said bromopicrin is provided with an inert carrier.

9. A method of controlling a plant pest, comprising exposing an environment of the plant to a pesticidally effective amount of bromopicrin, thereby controlling the plant pest.

10. The method of claim 9, wherein said environment of the plant is a soil.

11. The method of claim 9, wherein said plant pest is selected from the group consisting of a fungus, a bacterium, a nematode, an insect and a weed.

12. The method of claim 9, wherein said bromopicrin is provided with at least one additional pesticide.

13. The method of claim 9, wherein said bromopicrin is provided with an inert carrier.

14. A pesticide formulation, comprising a pesticidally effective amount of bromopicrin and a carrier suitable for fumigation.

15. The pesticide formulation of claim 14, wherein said carrier has a concentration of at least 0.5% by weight of the pesticide formulation.

16. The pesticide formulation of claim 14, further comprising at least one additional pesticide.

17. An article of manufacturing, comprising a packaging material and a formulation being identified for use in the control of plant pests, said formulation including, as an active ingredient, a pesticidally effective amount of bromopicrin and a suitable carrier.

18. The article of manufacturing of claim 17, further comprising at least one additional pesticide.

19. A method of disinfecting a substance, product or structure comprising fumigating the substance, product or structure with a pesticidally effective amount of a compound having the general formula: 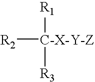
wherein:
R₁, R₂, R₃ and Z are each independently a substituent selected from the group consisting of hydrogen, halo, nitro, cyano, hydroxy, thiohydroxy, alkoxy, thioalkoxy and amine; and
X and Y are each independently absent or a carbon atom substituted by two substituents, each substituent is independently selected from the group consisting of hydrogen, halo, nitro, cyano, hydroxy, thiohydroxy, alkoxy, thioalkoxy and amine;
provided that the compound comprises at least two halo substituents and at least one nitro substituent,
and with the proviso that the compound is not chloropicrin, thereby disinfecting the substance, product or structure.

20. The method of claim 19, wherein X and Y are each absent.

21. The method of claim 19, wherein at least two of R₁, R₂ and R₃ are halo substituents.

22. The method of claim 19, wherein said at least two halo substituents are each a bromo substituent.

23. The method of claim 19, wherein said compound comprises at least three halo substituents.

24. The method of claim 23, wherein said at least three halo substituents are each a bromo substituent.

25. The method of claim 20, wherein said at least two halo substituents are each a bromo substituent.

26. The method of claim 25, wherein the compound is dibromonitromethane.

27. The method of claim 20, wherein the compound comprises at least three halo substituents.

28. The method of claim 27, wherein at least one of said at least three halo substituents is a bromo substituent.

29. The method of claim 19, further comprising fumigating said substance, product or structure with at least one additional pesticide.

30. The method of claim 19, wherein said compound is provided with an inert carrier.

31. A method of soil disinfestation, comprising exposing the soil to a pesticidally effective amount of a compound having the general formula: 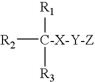
wherein:
R₁, R₂, R₃ and Z are each independently a substituent selected from the group consisting of hydrogen, halo, nitro, cyano, hydroxy, thiohydroxy, alkoxy, thioalkoxy and amine; and
X and Y are each independently absent or a carbon atom substituted by two substituents, each substituent is independently selected from the group consisting of hydrogen, halo, nitro, cyano, hydroxy, thiohydroxy, alkoxy, thioalkoxy and amine;
provided that the compound comprises at least two halo substituents and at least one nitro substituent,
with the proviso that the compound is not chloropicrin, thereby disinfecting the soil.

32. The method of claim 31, wherein the compound is dibromonitromethane.

33. The method of claim 31, further comprising administering to said soil at least one additional pesticide.

34. The method of claim 31, wherein said compound is provided with an inert carrier.

35. A method of controlling a plant pest, comprising exposing an environment of the plant to a pesticidally effective amount of a compound having the general formula: 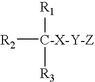
wherein:
R₁, R₂, R₃ and Z are each independently a substituent selected from the group consisting of hydrogen, halo, nitro, cyano, hydroxy, thiohydroxy, alkoxy, thioalkoxy and amine; and
X and Y are each independently absent or a carbon atom substituted by two substituents, each substituent is independently selected from the group consisting of hydrogen, halo, nitro, cyano, hydroxy, thiohydroxy, alkoxy, thioalkoxy and amine;
provided that the compound comprises at least two halo substituents and at least one nitro substituent,
with the proviso that the compound is not chloropicrin, thereby controlling the plant pest.

36. The method of claim 35, wherein the compound is dibromonitromethane.

37. The method of claim 35, wherein said compound is provided with at least one additional pesticide.

38. The method of claim 35, wherein said compound is provided with an inert carrier.

39. A pesticide formulation, comprising a pesticidally effective amount of a compound having the general formula: 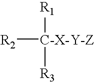
wherein:
R₁, R₂, R₃ and Z are each independently a substituent selected from the group consisting of hydrogen, halo, nitro, cyano, hydroxy, thiohydroxy, alkoxy, thioalkoxy and amine; and
X and Y are each independently absent or a carbon atom substituted by two substituents, each substituent is independently selected from the group consisting of hydrogen, halo, nitro, cyano, hydroxy, thiohydroxy, alkoxy, thioalkoxy and amine;
provided that the compound comprises at least two halo substituents and at least one nitro substituent,
with the proviso that the compound is not chloropicrin, and a carrier suitable for fumigation.

40. The pesticide formulation of claim 39, wherein X and Y are each absent.

41. The pesticide formulation of claim 39, wherein at least two of R₁, R₂ and R₃ are halo substituents.

42. The pesticide formulation of claim 39, wherein said at least two halo substituents are each a bromo substituent.

43. The pesticide formulation of claim 39, wherein said compound comprises at least three halo substituents.

44. The pesticide formulation of claim 43, wherein said at least three halo substituents are each a bromo substituent.

45. The pesticide formulation of claim 40, said at least two halo substituents are each a bromo substituent.

46. The pesticide formulation of claim 45, wherein the compound is dibromonitromethane.

47. The pesticide formulation of claim 40, wherein the compound comprises at least three halo substituents.

48. The pesticide formulation of claim 47, wherein at least one of said at least three halo substituents is a bromo substituent.

49. The pesticide formulation of claim 39, wherein said carrier includes at least one solvent.

50. The pesticide formulation of claim 39, further comprising at least one additional pesticide.

51. An article of manufacturing, comprising a packaging material and a formulation being identified for use in the control of plant pests, said formulation including, as an active ingredient, a pesticidally effective amount of a compound having the general formula: 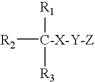
wherein:
R₁, R₂, R₃ and Z are each independently a substituent selected from the group consisting of hydrogen, halo, nitro, cyano, hydroxy, thiohydroxy, alkoxy, thioalkoxy and amine; and
X and Y are each independently absent or a carbon atom substituted by two substituents, each substituent is independently selected from the group consisting of hydrogen, halo, nitro, cyano, hydroxy, thiohydroxy, alkoxy, thioalkoxy and amine;
provided that the compound comprises at least two halo substituents and at least one nitro substituent,
with the proviso that the compound is not chloropicrin, and a suitable carrier.

52. The article of manufacturing of claim 51, wherein said carrier includes at least one solvent.

53. The article of manufacturing of claim 51, further comprising at least one additional pesticide.

54. A method of disinfecting a substance, product or structure comprising fumigating the substance, product or structure with a pesticidally effective amount of bromonitromethane, thereby disinfecting the substance, product or structure.

55. A method of soil disinfestation, comprising exposing the soil to a pesticidally effective amount of bromonitromethane, thereby disinfecting the soil.

56. A method of controlling a plant pest, comprising exposing an environment of the plant to a pesticidally effective amount of bromonitromethane, thereby controlling the plant pest.

57. A pesticide formulation, comprising a pesticidally effective amount of bromonitromethane, and a carrier suitable for fumigation.
